(19) United States
(12) Patent Application Publication
(10) Pub. No.: US 2013/0216827 A1
(43) Pub. Date: Aug. 22, 2013

(54) LAMINATE WITH A COLOR LAYER, AND METHOD FOR PRODUCING SAME

(71) Applicants: Markus Parusel, Messel (DE); Jonas Scherble, Rossdorf (DE); Achim Neuhaeuser, Mainz (DE); Ralf Richter, Hanau (DE); Guenther Dickhaut, Mannheim (DE); Herbert Bosch, Treuchtlingen (DE); Hans-Peter Erfurt, Spalt (DE); Heike Witte, Hilpolststein (DE)

(72) Inventors: Markus Parusel, Messel (DE); Jonas Scherble, Rossdorf (DE); Achim Neuhaeuser, Mainz (DE); Ralf Richter, Hanau (DE); Guenther Dickhaut, Mannheim (DE); Herbert Bosch, Treuchtlingen (DE); Hans-Peter Erfurt, Spalt (DE); Heike Witte, Hilpolststein (DE)

(21) Appl. No.: 13/800,348

(22) Filed: Mar. 13, 2013

Related U.S. Application Data
(63) Continuation of application No. PCT/EP2011/067668, filed on Oct. 11, 2011.

(30) Foreign Application Priority Data
Oct. 25, 2010 (DE) 10 2010 042 857.4

(51) Int. Cl. B32B 27/08

(52) U.S. Cl. CPC B32B 27/08
USPC 428/337; 156/309.3; 156/277; 428/423.5

(57) ABSTRACT

The present invention relates to a laminate comprising at least one thermoplastic substrate and at least one colour layer, wherein the thermoplastic substrate comprises polyamide, to which at least one colour layer comprising polyurethane crosslinking has been applied.

### BACKGROUND OF THE INVENTION

1. Field of the Invention

The present invention relates to a laminate comprising at least one thermoplastic substrate and at least one colour layer. The invention further describes a process for production of this laminate.

2. Discussion of the Background

Laminates with a colour layer, especially printed films, are frequently used for production of decorated plastic components with exceptional surface quality. In general, the colour layer is provided with a reinforcement layer, such that a three-layer structure is obtained, with the colour layer arranged between the printed substrate and the reinforcement layer. This affords very durable plastic components, the printed film being crucial for the durability.

However, only polycarbonate-based substrates are known to date. The durability of polycarbonates, which is based especially on chemical and mechanical stability and on weathering stability, is, though, relatively limited. For instance, a requirement has recently arisen, for example in the motor vehicles sector, for chemical resistances which cannot be achieved with polycarbonates. For instance, these plastic parts frequently come into contact with oils or oil-water or water-oil emulsions from cosmetics or foods, which can contain relatively aggressive components. Therefore, high-quality plastic surfaces for motor vehicles are subjected to tests with sun cream, sun oil or lotions which, in combination with UV irradiation, lead to significant stress on the surfaces. These tests show that polycarbonates, for example, readily form stress cracks and age prematurely.

### SUMMARY OF THE INVENTION

In view of the prior art, it is an object of the present invention to provide laminates comprising at least one thermoplastic substrate and at least one colour layer, which have an outstanding profile of properties. For instance, the laminate should have exceptional durability. More particularly, the laminate should exhibit chemical resistance which meets very high demands, as have recently been made, for example, in the motor vehicles sector. For instance, the laminate should have a high resistance especially toward water-oil or oil-water emulsions such as cosmetics, for example sun cream.

In addition, the laminate should be stable to mechanical stress and have high weathering stability, a long service life, and especially a high stability with respect to UV radiation.

It was a further object of the present invention to provide a laminate which exhibits high optical quality, especially in relation to streaks, strips, gel bodies and other impurities.

In addition, the laminate was to be producible inexpensively with high and uniform quality.

It was another object of the present invention to provide a laminate with a colour layer, which can be reformed in a simple manner and without significant losses of quality.

Furthermore, it was to be possible to provide a printed laminate with a reinforcement layer without the quality of the colour layer being unacceptably impaired.

These objects, and further objects which are not stated explicitly but can immediately be derived or discerned from the connections discussed herein by way of introduction or from the description which follows, are achieved by a laminate having all features of claim 1. Appropriate modifications to the laminate are protected in dependent claims.

### BRIEF DESCRIPTION OF DRAWINGS

FIG. 1 shows an extruder with a heatable die, the extruder having a die body (1) with a die lip (2) and a lip gap (3). The die lip (2) is provided with a heater (4).

FIG. 2 shows a polishing system with three rolls A, B and C, a melt reservoir D, nip 1, and a cooling zone (E).

### DETAILED DESCRIPTION OF THE INVENTION

The present invention accordingly provides a laminate comprising at least one thermoplastic substrate and at least one colour layer, which is characterized in that at least one thermoplastic substrate comprises polyamide, to which at least one colour layer comprising polyurethane crosslinking has been applied.

The laminate of the present invention exhibits an extremely good profile of properties. For instance, the laminate has excellent durability. More particularly, the laminate exhibits chemical resistance which meets very high demands, as recently made, for example, in the motor vehicles sector. In addition, the laminate has a surprisingly high stability with respect to water-oil or oil-water emulsions such as cosmetics, for example sun cream.

In addition, the laminate is stable to mechanical stress and has high weathering stability, a long service life, more particularly a high stability with respect to UV radiation.

Furthermore, an inventive laminate exhibits high optical quality, especially in relation to streaks, strips, gel bodies and other impurities.

In addition, a laminate of the present invention can be produced inexpensively with high and uniform quality.

Moreover, an inventive laminate with a colour layer can be reformed in a simple manner and without significant losses of quality.

In addition, a printed laminate can be provided with a reinforcement layer without unacceptable impairment of the quality of the colour layer.

The present invention provides a laminate. The term “laminate” essentially describes a structure whose thickness is much less than the length or width thereof. Accordingly, this term includes films and thin mouldings.

The laminate comprises at least one thermoplastic substrate and at least one colour layer. The thermoplastic substrate comprises polyamide.

Polyamides in the context of the present invention are thermoplastic polymers whose repeating units are connected via an amide group (—CO—NH—). Surprising advantages are exhibited by polyamides which have been prepared essentially from aromatic, aliphatic or cycloaliphatic dicarboxylic acids and cycloaliphatic diamines.

Alternatively, the polyamides may also be of the AB type, preparable from aminocarboxylic acids. However, polyamides usable with preference are of the AA/BB type, formed from dicarboxylic acids and diamines. More particularly, the polyamides may be PA PACM12 or PA MACM12. In addition, it is possible to use PA11 or PA12, referring to the customary nomenclature.

The polyamides usable in accordance with the invention and hence the substrates produced, especially polyamide mouldings or polyamide films, are preferably prepared by polycondensation essentially from aromatic, cycloaliphatic or aliphatic dicarboxylic acids, preferably from aromatic or aliphatic dicarboxylic acids and cycloaliphatic diamines. “Essentially” means that up to 40% by weight of, preferably up to a maximum of 10% by weight of, and more preferably no further components such as aminoundecanoic acid, monofunctional units or further dicarboxylic acids and/or diamines may be incorporated. Alternatively, the polyamides may also be of the AB type, preparable from aminocarboxylic acids. Preferably, however, polyamides of the AA/BB type can be prepared from dicarboxylic acids and diamines.

The cycloaliphatic or aliphatic dicarboxylic acids used are cycloaliphatic, partly cyclic-aliphatic, linear or branched dicarboxylic acids having 4 to 20 and preferably having 8 to 16 carbon atoms. Particular preference is given to a dicarboxylic acid having 12 carbon atoms, very particular preference to dodecanedioic acid (formula 1):

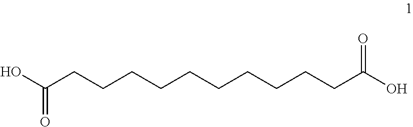 [SMILES: O=C(O)CCCCCCCCCCC(=O)O]

The aromatic dicarboxylic acids used are dicarboxylic acids having one or more aromatic rings. Examples are phthalic acid, isophthalic acid or terephthalic acid.

The cycloaliphatic diamines are aliphatic diamines which have one to three aliphatic rings composed of 5 to 8 and preferably 6 carbon atoms. They are preferably diamino-dicyclohexylmethane (formula 2) or 3,3-dimethyl-p-diamino-cyclohexylmethane (formula 3):

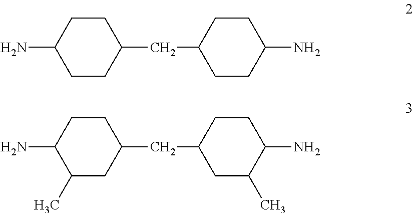

In a preferred aspect, it is possible to use a polyamide which has been prepared essentially from an aliphatic or cycloaliphatic dicarboxylic acid and a cycloaliphatic diamine, and an end group content of less than 170 mmol/kg, preferably less than 100 mmol/kg. More preferably, the carboxyl and/or amino end group content, preferably the amino end group content, is less than 100 mmol/kg, more preferably less than 35 mmol/kg.

In a particular embodiment, the polyamide present in the substrate is preferably PA PACM12 or PA MACM12. These polyamides can be obtained especially in the form of moulding materials from Evonik Degussa GmbH under the TROGAMID® trade name, and these polyamides include, for example, TROGAMID® CX7323.

Another preferred embodiment involves polyamides based on aromatic dicarboxylic acids.

In addition to polyamide, the substrate may comprise further additives, processing aids for film production, or further plastics. These include stabilizers, plasticizers, fillers such as fibres, and dyes. In general, however, the polyamide content in the substrate is at least 50% by weight, preferably at least 80% by weight and more preferably at least 90% by weight, without any intention that this should impose a restriction.

The substrate comprising polyamide is, like the laminate, a shaped body whose thickness is much less than the length or width, and so the polyamide-comprising substrate is generally an extruded semifinished product. Accordingly, the substrate may preferably be in the form of a film, though this is not intended to imply that the substrate can be wound.

The substrate to be provided with a colour layer can preferably be used in a thickness of 25 to 5000 μm, especially 50 to 2000 μm, more preferably 100 to 1000 μm. The side of the substrate envisaged for coating and the other side of the substrate may be smooth or have a surface structure, preference being given to a matt surface of the side to be coated. For aesthetic reasons, a smooth surface of the uncoated side of the substrate may be preferred.

The polyamide-containing mouldings or films used as substrates may, alternatively to an untreated, transparent and clear film or a corresponding moulding, also be modified during the extrusion process. For instance, the films or mouldings can be coloured by addition of colorants such as pigments and/or dyes. In addition, addition of suitable additives can improve or influence scratch resistance, IR or UV absorption or the tactile properties. Addition of microparticles can also alter the light scattering. Scratch resistance, antisoiling performance or altered tactile properties can also be brought about by appropriate coatings. The expression “polyamide mouldings” hereinafter may also be synonymous for polyamide films.

In addition to the substrate, an inventive laminate comprises at least one colour layer which has polyurethane crosslinking. Accordingly, the colour layer comprises a binder which can be crosslinked via isocyanates.

The coating material used to obtain the colour layer may, for example, be a printing ink which is elastomeric in the dried/cured state and can therefore be deformed with the film in the course of deforming without crack formation or deterioration in the optical properties. As a binder, the colour may therefore preferably comprise a cellulose or a cellulose derivative, for example nitrocellulose, a polyurethane, a polyester, a polycarbonate, a polyamide or a poly(meth)acrylate. These polymers can be used individually or as a mixture.

Preferably, the binder used in the colour may have a weight-average molecular weight in the range from 1000 to 50 000 g/mol, more preferably in the range from 2000 to 20 000 g/mol. The number-average molecular weight of the binder used is preferably in the range from 1000 to 50 000 g/mol, more preferably in the range from 2000 to 20 000 g/mol. The number-average and weight-average molecular weights can be determined by known processes, for example gel permeation chromatography (GPC), preferably using a PMMA standard.

The functionality needed for curing in the binder present in the colour is achieved by means of hydroxyl groups, which can be crosslinked with isocyanates or isocyanate derivatives to form polyurethanes. Surprising advantages can be achieved especially with binders which, before the crosslinking, have a hydroxyl number in the range from 0.1 to 50 mg KOH/g, more preferably 0.5 to 30 mg KOH/g. The hydroxyl number can be determined, for example, according to DIN EN ISO 4629.

In addition to the binder which has polyurethane crosslinking, the colour layer comprises at least one colorant. A colorant is, according to DIN 55943, the collective term for all colouring substances. The colouring substances include soluble dyes and inorganic or organic pigments. These colorants can be used individually or as a mixture of two or more. For instance, it is especially possible to use mixtures of organic colour pigments with soluble organic dyes. In addition, it is possible to use mixtures which comprise inorganic and organic colour pigments. Furthermore, it is possible to use mixtures which, in addition to the inorganic colour pigments, comprise soluble organic dyes. Additionally appropriate are mixtures comprising soluble dyes and inorganic and organic pigments. The colorants detailed above are described, inter alia, in Kirk, Othmer Encyclopedia of Chemical Technology, Third Edition, vol. 19, pp. 1 to 78 and in Ullmann's Encyclopedia of Industrial Chemistry 5th Edition on CD-ROM.

The type of colorant depends on the processing of the laminate, for which a high thermal stability may be required. Accordingly, it is possible with preference to use very thermally stable pigments, such that they do not decompose, sublime or change in hue in the course of in-mould coating, as a result of the temperature which may arise in the course of processing.

The pigments present with preference in the colour layer may be any pigments. It is possible to use, for example, without any restriction thereto, titanium dioxide, zinc sulphide, pigment carbon black, azodiaryl yellow, isoindole yellow, diarylide orange, quinacridone magenta, diketopyrrolo red, copper phthalocyanine blue, copper phthalocyanine green, dioxazine violet and diketo metal oxide.

A fairly comprehensive list of further useable pigments is published in Colour Index International, Fourth Edition Online, 2001, by the Society of Dyers and Colourists in association with the American Association of Textile Chemists and Colorists.

It is also possible to use effect pigments such as, without any restriction thereto, metal oxide-coated mica and metallic pigments. The amount of chromatic pigment is usually 1 to 50% by weight, preferably 3 to 45% by weight, based on the weight of the printing ink, depending on the type of pigment, the desired hiding power and the printing process selected.

White pigment is usually used in an amount of 20 to 50% by weight, preferably 25 to 45% by weight. The chromatic pigments are frequently used in an amount of 1 to 20% by weight, depending on the type and hue, and on the printing process used. Metal oxide-coated mica and metallic pigments are frequently used in an amount of 1 to 20% by weight, depending on the type and hue, and on the printing process used.

In a preferred aspect of the present invention, an adhesion promoter layer may be provided on the colour layer. The adhesion promoter layer is generally matched to the binder used in the colour layer and the reinforcement layer to be applied to the adhesion promoter layer. The adhesion promoter layer preferably comprises a cellulose or a cellulose derivative, for example nitrocellulose, a polyurethane, a polyester, a polycarbonate, a polyamide or a poly(meth)acrylate. These polymers can be used individually or as a mixture.

In a preferred embodiment, an inventive laminate may have a reinforcement layer, the colour layer being provided between the thermoplastic substrate and the reinforcement layer. The moulding materials and/or films usable for production of the reinforcement layer described may especially include thermoplastic polymers. The preferred polymers include cellulose or cellulose derivatives, polystyrenes, polystyrene copolymers, for example ABS, polyurethanes, polyesters, polycarbonates, polyamides, polyolefins, especially polyethylene or polypropylene, polyvinyl chlorides, poly(N-methylmethacrylimides) (PMMI) and/or polymethyl methacrylates (PMMA). These polymers can be used individually or as a mixture. In addition, the reinforcement layer may comprise fillers, especially fibres.

The substrate to be used for production of the present laminate can preferably be obtained by extrusion processes, especially for production of semifinished products, and these processes also include film extrusion processes.

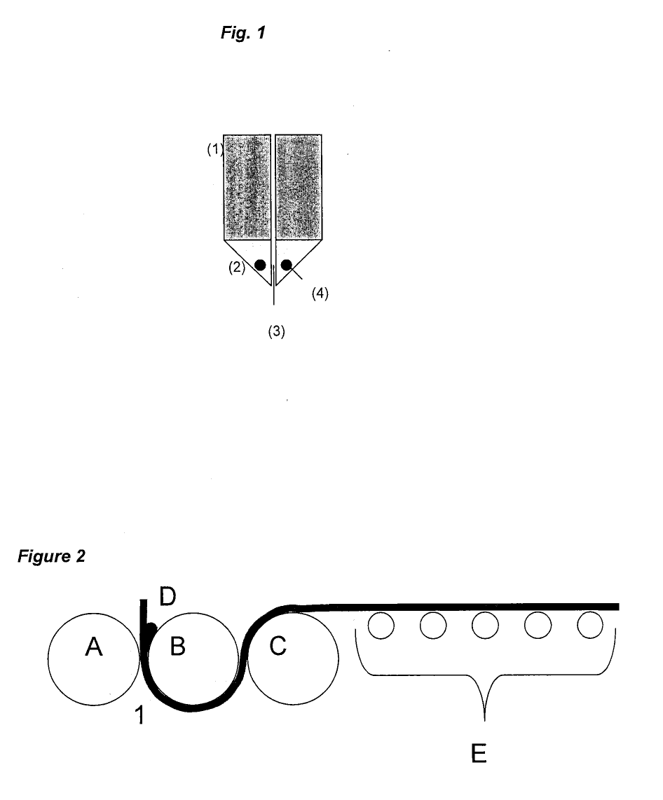

Preferably, an extruder with a heatable die can be used, as shown by way of example in FIG. 1, this extruder comprising a die body (1) with a die lip (2) and a lip gap (3). The die lip (2) is provided with a heater (4).

In a particular configuration of the extrusion process, at least one region of the film die, preferably the die lip (2), may have a temperature higher by 10° C. to 100° C., preferably by 20° C. to 80° C., more preferably 30° C. to 70° C., than the die body (1). It is especially preferred that the temperature of the die lip (2) is between 10° C. and 100° C., preferably 20° C. to 80° C., more preferably 30° C. to 70° C., higher than the temperature of the die body (1), and that the die body (1) has a temperature not more than 5° C. higher than, preferably the same temperature as, the extruder.

In a particular variant of the process, the die body (1) may generally have a temperature between 250° C. and 330° C. The die lip (2) may at the same time have a temperature between 290° C. and 370° C. The die lip (2) preferably has an additional heater (4). The heater can be implemented, for example, by means of inserted heating cartridges or flat heating elements. These can be heated, inter alia, electrically or by means of a heated medium, for example oil. The temperature can be determined, for example, by means of thermocouples, resistance thermometers, or contactless temperature measurement methods such as IR thermometers.

The temperatures reported are measured at the inner wall or very close to the inner wall of the extruder barrel, at the inner wall of the die body or very close to the inner wall of the die body, and at the inner wall of the die lip or very close to the inner wall of the die lip.

In the region within the extrusion die, i.e. within the film die upstream of the die outlet, the melt pressure must be high enough to keep the volatile constituents still dissolved in the polymer, such as water or possibly monomers, completely in solution and thus to prevent the formation of gas bubbles. This can be ensured, for example, via the geometry of the extrusion die, the residual moisture content of the moulding material used, the melt volume flow rate and the processing temperatures.

More particularly, a preferred process for producing the substrate can be performed in the following process steps:
The moulding material can be melted at a temperature between 250° C. and 330° C. in an extruder.
The moulding material can exit from the extruder via a die lip (2) having a temperature between 290 and 370° C.
The moulding material can be drawn off in a thickness between 10 μm and 10 mm by means of at least one roller or at least one belt.
The moulding material can be conveyed further to cool it.

The extruder used may be any single-screw, twin-screw or multiscrew extruder suitable for processing of polyamides. These extruders may be configured with or without, preferably without, vents. The extruders may have several temperature zones or a homogeneous temperature in the region of the extruder barrel.

Additionally preferably, the polyamide moulding material has a maximum water content of 0.1% by weight, preferably of 0.02% by weight. The low water content improves the optical quality, especially in relation to bubble formation and/or opacity, which is to be prevented.

After leaving the extruder, the moulding material is cooled. The cooling process is typically matched to the requirements on the laminate.

Thin laminates, for example films having a thickness of at most 250 μm, preferably at most 100 μm, can be produced, inter alia, by the chill-roll process, wherein the melt web is laid onto a chill roll, such that the other side of the film at this moment is not in contact with a roll, i.e. there is no opposite roll or a polishing nip.

To produce thicker laminates, which may have, for example, a thickness of at least 50 μm, preferably at least 100 μm, preference is given inter alia to polishing processes, without any intention that this should impose a restriction. The polishing process enables a particularly good thickness distribution of the films over the extrusion width and particularly good surface qualities, which in turn depend on the quality of the roll surface.

In the polishing process, the plasticized polymer material which exits from the die, preferably slot die, is supplied to a polishing system, which comprises several rotating rolls connected in series, around which the polymer material can be conducted, and at least two rolls are arranged such that there is an adjustable nip between this adjacent roll pair, by means of which the thickness of the polymer material can be influenced. Especially for production of films with particularly good thickness distribution over the extrusion width, the setting of the extrusion conditions in the first roll nip, which directly follows the melt exit from the die, is selected so as to form a melt reservoir/bulge, with which the very fine differences in thickness in film can be balanced out in a site-dependent manner. Quite generally, it is possible to differently configure the number, arrangement and position of the rolls and the number of adjacent roll pairs which can be used to adjust a shaping nip, without any intention that this should impose a restriction. Among others, I, F, L and Z arrangements of rolls of the polishing system are known, all rolls being arranged in one line in the case of an I arrangement. In the other arrangements, at least one roll is arranged outside a line.

Preferably, a polishing system comprising at least three rolls A, B and C can be used, in which case the melt can first be applied to a nip 1 between rolls A and B, such that a melt reservoir D is formed in nip 1, as shown by way of example in FIG. 2. The roll arrangement of the polishing system in FIG. 2 corresponds here to the I configuration in a horizontal position. The polishing system comprising three rolls A, B and C may be followed downstream by a cooling zone (E) which can remove the residual heat from the film.

Before the application of the colour, which can also be referred to as printing ink, the substrate, for example a film, can optionally be pretreated. Typical pretreatments include cleaning with solvents or aqueous cleaning agents, activation by means of flame treatment, UV irradiation, corona treatment, plasma treatment or treatment with ionized gas, for example ionized air, in order to reduce incidence of dust.

The inventive laminate comprises a colour layer which can be obtained by the application of colour. In addition to the components detailed above, more particularly the colorant and the binder, the colour comprises at least one curing agent or crosslinking agent which can bring about polyurethane crosslinking.

The preferred crosslinking agents include especially polyisocyanates or compounds which release polyisocyanates. Polyisocyanates are compounds having at least 2 isocyanate groups.

The polyisocyanates usable in accordance with the invention may comprise any aromatic, aliphatic and/or cycloaliphatic polyisocyanates.

The preferred aromatic polyisocyanates include phenylene 1,3- and 1,4-diisocyanate, naphthylene 1,5-diisocyanate, toluidine diisocyanate, tolylene 2,6-diisocyanate, tolylene 2,4-diisocyanate (2,4-TDI), diphenylmethane 2,4′-diisocyanate (2,4′-MDI), diphenylmethane 4,4′-diisocyanate, the mixtures of monomeric diphenyl-methane diisocyanates (MDI) and oligomeric diphenylmethane diisocyanates (polymer MDI), xylylene diisocyanate, tetramethylxylylene diisocyanate and triisocyanatotoluene.

Preferred aliphatic polyisocyanates have 3 to 16 carbon atoms, preferably 4 to 12 carbon atoms, in the linear or branched alkylene radical, and suitable cycloaliphatic or (cyclo)aliphatic diisocyanates advantageously 4 to 18 carbon atoms, preferably 6 to 15 carbon atoms, in the cycloalkylene radical. (Cyclo)aliphatic diisocyanates are understood sufficiently by the person skilled in the art to mean NCO groups bonded both cyclically and aliphatically, as is the case, for example in isophorone diisocyanate. In contrast, cycloaliphatic diisocyanates are understood to mean those which have only NCO groups bonded directly on the cycloaliphatic ring, for example H₁₂MDI. Examples are cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, nonane triisocyanate such as 4-isocyanatomethyl-1,8-octane diisocyanate (TIN), decane di- and triisocyanate, undecane di- and triisocyanate, dodecane di- and triisocyanate.

Preference is given to isophorone diisocyanate (IPDI), hexamethylene diisocyanate (HDI), diisocyanatodicyclohexyl-methane (H₁₂MDI), 2-methylpentane diisocyanate (MPDI), 2,2,4-trimethylhexamethylene diisocyanate/2,4,4-trimethyl-hexamethylene diisocyanate (TMDI), norbornane diisocyanate (NBDI). Very particular preference is given to using IPDI, HDI, TMD₁ and H₁₂MDI, and it is also possible to use the isocyanurates.

Likewise suitable are 4-methylcyclohexane 1,3-diisocyanate, 2-butyl-2-ethylpentamethylene diisocyanate, 3(4)-iso-cyanatomethyl-1-methylcyclohexyl isocyanate, 2-isocyanato-propylcyclohexyl isocyanate, 2,4′-methylenebis(cyclohexyl) diisocyanate, 1,4-diisocyanato-4-methylpentane.

Preferred aliphatic, cycloaliphatic and araliphatic, i.e. aryl-substituted aliphatic, diisocyanates are described, for example, in Houben-Weyl, Methoden der organischen Chemie [Methods of Organic Chemistry], volume 14/2, pages 61-70, and in the article by W. Siefken, Justus Liebigs Annalen der Chemie 562, pages 75-136.

It will be appreciated that it is also possible to use mixtures of the polyisocyanates.

In addition, preference is given to using oligo- or polyisocyanates which can be prepared from the di- or polyisocyanates mentioned, or mixtures thereof, by linkage by means of urethane, allophanate, urea, biuret, uretdione, amide, isocyanurate, carbodiimide, uretonimine, oxadiazinetrione or iminooxadiazinedione structures. These preferred classes of polyisocyanates can be prepared by dimerization, trimerization, allophanatization, biuretization and/or urethanization of simple diisocyanates. These compounds having more than two isocyanate groups per molecule include, for example, the reaction products of simple diisocyanates, for example IPDI, TMDI, HDI and/or H₁₂MDI, with polyhydric alcohols (e.g. glycerol, trimethylolpropane, pentaerythritol) or polyfunctional polyamines, or triisocyanurates which are obtained by trimerization of simple diisocyanates, for example IPDI, HDI and H₁₂MDI, particular preference being given to HDI-biuret.

Of particular interest are therefore colours which contain preferably 0.5 to 20% by weight, more preferably 2 to 10% by weight, of crosslinking agent, based on the total weight of the colour.

In the case of use of polyisocyanates as crosslinking agents, the reaction of the hydroxyl groups present in the binder with the organic polyisocyanates can be performed here, according to the end use of the reaction products, with 0.5 to 1.1 NCO groups per hydroxyl group. The reaction is preferably performed in such a way that the amounts of the organic polyisocyanate, based on the total hydroxyl content of the components present in the reaction mixture, are present in an amount of 0.7 to 1.0 isocyanate group per hydroxyl group.

The colour may comprise further customary solvents, additives and/or processing aids, and these components are typically matched to the printing technique and use requirements.

For instance, customary solvents, additives and/or processing aids are detailed in EP 0 688 839 B1, and these solvents, additives, processing aids etc. are incorporated into this application for the purposes of disclosure.

The further properties of the colour depend on the printing process, and these properties are detailed inter alia in Kipphan, Handbuch der Printmedien [Handbook of the Printing Media], Springer-Verlag, Berlin, 2000, ISBN-10 3540669418, and these properties are incorporated into this application for the purposes of disclosure.

Particularly suitable printing inks are obtainable, for example, from Pröll K G, Weissenburg, Bavaria, Germany, under the NoriAmid® name.

The colour detailed above can be applied to the substrate by known processes, preferably printing processes. Suitable printing processes for application of printing ink layers are known; in principle, all printing processes such as relief printing, intaglio printing, flexographic printing, offset printing, screen printing, pad printing, digital printing, especially inkjet printing and laser printing are suitable. Preference is given to intaglio printing, flexographic printing and screen printing, particular preference to screen printing. With regard to screen printing, preference is given to flat bed screen printing. These printing processes are explained inter alia in Kipphan, Handbuch der Printmedien, Springer-Verlag, Berlin, 2000, ISBN-10 3540669418, and these processes are incorporated into this application for the purposes of disclosure.

After the printing, the coating is cured by customary processes, and dried in the case of use of solvents. The curing or drying time can vary according to the type and amount of the solvent and the degree of crosslinking. The curing or drying time is preferably selected such that the colour layer retains an elasticity sufficient for a possible reforming process, but is crosslinked to a sufficient degree that the colour layer has a strength sufficient for a possible reforming and further treatment. A drying or curing time of at least 5 minutes, more preferably at least 10 minutes and most preferably at least 20 minutes at temperatures of approx. 50° C. or, according to the dryer, 90° C. leads in many cases to a sufficiently high stability of the colour layer. For the reasons mentioned, the drying time should not be too long since brittleness of the colour layer can otherwise occur, which complicates reforming. In this case, the curing depends on the temperature. At 50° C., it is therefore possible to achieve surprising advantages if the drying time is at most 20 hours, preferably at most 10 hours. A higher temperature can accelerate the drying operation, such that the drying time at 90° C. is preferably at most 5 hours, more preferably at most 4 hours.

If an adhesion promoter layer is applied to the substrate provided with a colour, the adhesion promoter layer can be dried together with the colour, in which case the colour can be cured during the drying of the adhesion promoter layer. The adhesion promoter layer can be applied to the substrate by the same processes as the colour layer, particular preference being given to applying the colour layer and the adhesion promoter layer by screen printing, especially flat bed screen printing.

Printed laminates produced in accordance with the invention, preferably polyamide films, more preferably flexible polyamide films, can be used inter alia for lamination onto moulding materials, wood, glass or metals, preferably moulding materials.

The lamination can be effected, for example, by adhesion bonding on a surface of the laminate, in which case the lamination can be effected on the printed or unprinted side. Furthermore, the hot lamination of the film onto another film or onto a sheet is also possible. The inventive films can also be laminated with one or more carrier films.

The substrate provided with a crosslinked colour layer can be reformed by known processes, the type of reforming process and the process parameters depending on the end use and the properties of the laminate. Surprisingly, the inventive laminate can be shaped by deep drawing, thermoforming or high-pressure deforming.

As a guide, for example for a deformation depth up to 1.2 mm with a film thickness of 250 μm, the following parameters can be established:

heat above and below: 270 to 300° C., preferably 280 to 290° C.;
heating time 5 to 15 seconds, preferably 8 to 10 seconds;
air heating 280 to 340° C., preferably 300 to 320° C.;
mould heating 90 to 130° C., preferably 100 to 110° C.;
high pressure approx. 100 to 200 bar, preferably 140 to 160 bar;
high pressure time approx. 2 to 8 seconds, preferably approx. 3 to 5 seconds.

In addition, the polyamide film can be coated in the mould with one or more polymeric materials, such as a moulding material. This may especially follow a reforming. Alternatively, it is of course possible to adhesive bond mouldings obtainable from the moulding material and the laminate, which may optionally be reformed, to one another.

The optionally reformed laminate can be coated in the mould by customary injection moulding processes. The common injection moulding materials which can be used for in-mould coating of the laminate comprising a crosslinked colour layer are particularly, but not exclusively, polyamides, polyesters, polycarbonates, polystyrenes, polystyrene copolymers, for example ABS, poly(N-methylmethacrylimides) (PMMI) and/or polymethyl methacrylates (PMMA). Preferred materials for in-mould coating are polyamides or polymethyl methacrylates.

In addition, the laminates can be subjected to one or more of the following processing steps before or after the application of a reinforcement layer: reforming with or without heating of the film; cutting to size. The processing of the film is not restricted to the processes mentioned. The processing methods can be used in a different sequence from that specified. It is likewise also possible to repeat processing steps once or more than once.

The present invention will be illustrated in detail hereinafter with reference to examples, without any intention that this should impose a restriction.

### PRODUCTION EXAMPLES

### Production of the Polyamide Film

The water content was determined according to Karl Fischer. The end groups were determined by means of titration.

### Production of the Polyamide Films or Mouldings

The polyamide film was produced by methods known per se, for example extrusion through a slot die, as in the case of flat film extrusion, blown film extrusion, or by solution casting.

The polymer moulding can optionally also be configured in multilayer form by adhesion bonding, extrusion coating or lamination in further process steps.

The examples were produced on a conventional flat film plant from Collin. This involved introducing the polyamide, preferably in pellet form, into a funnel, from which it is conveyed into the extruder. The extruder consisted of a typically metallic barrel, which was heated from the outside, and of an extruder screw, which turned about its own axis in the extruder and hence conveyed the polymer from the intake region beyond the funnel orifice through the extruder. In alternative embodiments, it is also possible to use twin-screw or multiscrew extruders. As a result of the heating from the outside and the shearing of the polymer in the extruder, the polymer melted and passed beyond the tip of the extruder screw into the extrusion die in the form of the film die (or generally: slot die). Here, the polyamide melt was converted to a flat shape and exited from the film die in flat form through the die nip. The film die can also be fed with melt from several extruders, so as to form multilayer films. Subsequently, the polymer sheet was cooled on at least one roll and then wound.

The extruder used for the tests, which had a closed barrel and two separately heatable extruder zones and did not have vents, had a screw diameter of 35 mm at an L/D ratio (length of the screw/diameter of the screw) of 25. A commercial three-zone screw was used.

For the tests, the following temperature settings on the extrusion plant were made:

Intake (zone beyond the funnel): 240° C.
Extruder zone 1: 280° C.
Extruder zone 2: 290° C.
Transition region: 290° C.

### Film die: 290° C.

Lip heating: 350° C.

### Process Variant A—Chill Roll Process

The films were produced in the test setup in single-layer form in what is called the chill roll process, and have a thickness of 50 μm. Subsequently, the films were assessed visually for their quality. For this purpose, the films were compared and assessed visually with regard to optical quality compared to a reference specimen in saleable quality. Optical quality is understood here to mean, inter alia, the parameters of streaks, surface quality, number of gel bodies, number of impurities and number of particles of degraded material. All specimens which were considered to be saleable received the rating (+). The specimens which were just unsaleable received the rating (o) and the specimens which were clearly and very clearly unsaleable received the ratings (−) and (—) respectively.

Polyamide PA1 was polyamide PA PACM 12 from Evonik Degussa GmbH, for example based on the composition of TROGAMID® CX7323. Polyamide PA2 is a medium-viscosity PA PACM 12.

| | | | | Amino | Carboxyl | |
|---|---|---|---|---|---|---|
| | | | KF | end | end | Total |
| | Material | Film | water | groups | groups | end |
| Example | designation | quality | content | mmol/kg | mmol/kg | groups |
| 1 | PA1 | + | <0.01 | 31 | 67 | 98 |
| 2 | PA2 | + | 0.014 | 20 | 68 | 88 |
| 3 | PA1 | + | 0.024 | 20 | 88 | 108 |
| 4 | PA1 | + | <0.02 | 16 | 75 | 91 |
| 5 | PA1 | + | 0.019 | 10 | 79 | 89 |
| 6 | PA1 | + | <0.02 | 11 | 73 | 84 |
| 7 | PA1 | + | 0.02 | 21 | 69 | 90 |
| 8 | PA2 | + | 0.009 | 26 | 64 | 90 |

### Process Variant B—Polishing Process

A plasticized melt obtained by the above extrusion processes was cooled while being shaped between two adjacent rolls (A+B), the roll nip of which had been set to 250 μm, and by means of a further downstream roll (C). The arrangement of the rolls with respect to one another is shown in detail in FIG. 2. To produce a particularly good thickness distribution, a melt reservoir (D) which was small in size and was homogenous over the extrusion width was present here in the roll nip 1. The roll arrangement of the polishing system corresponded here to the I configuration in horizontal alignment, though it is also possible to use other polishing systems for production of the film. The polishing system consisting of the three rolls A, B and C is followed downstream by a cooling zone (E) which removes the residual heat from the film.

Temperature of roll A: 70° C.
Temperature of roll B: 80° C.
Temperature of roll C: 140° C.

A 250 μm film was obtained in particularly good optical quality and particularly good thickness distribution.

### EXAMPLES

A 250 μm-thick film based on TROGAMID® CX7323, which was obtained by the above process in process variant B according to the polishing process, was prepared for the later reforming process by means of a laser (holes to accommodate the centring pins). The prepared film was printed with printing inks which enable isocyanate crosslinking and are obtainable commercially from Pröll KG using a screen printing process (NoriAmid®). The printing inks were mixed with an isocyanate hardener (Härter 8125, obtainable from Pröll KG), and admixed with a thinner (SMK 090, obtainable from Pröll KG), in order to adjust the viscosity to the viscosity requirements. Subsequently, an adhesion promoter layer (NoriAmid® APM, obtainable from Pröll KG) was applied.

The decor/layout was implemented as follows:

Inscription colour (logos): NoriAmid® 770+10% Härter
8125+10% SMK 090
   Background colour: NoriAmid® 952+10% Härter
8125+10% SMK 090
   Adhesion promoter: NoriAmid® APM+10% SMK 090

### Print Parameters:

The printing was effected without preliminary temperature control using a 100-40y fabric.

All layers were dried directly after the printing in a jet dryer. The individual zones were set to the following temperatures: 85° C./90° C./25° C. The belt speed was 5 m/min. This was followed by the heat treatment of the printed film (including adhesion promoter layer) at 90° C. for 3 h.

Several days later, the printed films were reformed by means of the HPF process on an SAMK 400-42 reforming system, commercially available from Niebling-Junior Kunststoffverarbeitung—Werkzeugbau e.K, to give a cover.

### Process Parameters—Reforming:

High pressure (target/actual): 150 bar/145 bar
Total high pressure time: 4 s (150 bar, ramp: 1 s)
Heating time: 8 s
Upper/lower heating: 280° C.
Air heating: 300° C.
Mould heating: 110° C.

The settings resulted in a film temperature (underside) of approx. 120-125° C. The cycle time was 21.1 s.

Once the cover of the film box had been punched out, the film inserts were coated in the mould with TROGAMID® CX 7323 and oriented with Makrolon® 2205.

Process Parameters—in-Mould Coating Operation for TROGAMID® CX 7323
Barrel temperatures: 310/300/290/280° C.
Injection time: 0.6 sec.
Injection pressure: 1200 bar
Hold pressure: 500 bar
Hold pressure time: 5 sec.
Cooling time: 15 sec.
Mould temperatures: Die side: 75° C., ejector side: 35° C.
Process Parameters—in-Mould Coating Operation for Makrolon® 2205
Barrel temperatures: 290/280/275/265° C.
Injection time: 0.6 sec.
Injection pressure: 1500 bar
Hold pressure: 570 bar
Hold pressure time: 4 sec.
Cooling time: 15 sec.
Mould temperatures: Die side: 75° C., ejector side: 35° C.

A laminate with an excellent profile of properties was obtained, which both satisfied high aesthetic demands and exhibited excellent resistance to chemical and mechanical stresses.

1. A laminate, comprising:
at least one thermoplastic substrate; and
at least one colour layer,
wherein said at least one thermoplastic substrate comprises polyamide, to which at least one colour layer comprising polyurethane crosslinking has been applied.

2. The laminate according to claim 1, wherein the laminate comprises an adhesion promoter layer which has been applied to the colour layer.

3. The laminate according to claim 1, wherein the laminate comprises a reinforcement layer, the colour layer having been provided between the thermoplastic substrate and the reinforcement layer.

4. The laminate according to claim 1, wherein the thermoplastic substrate has a thickness in the range from 25 μm to 5000 μm.

5. A process for producing a laminate according to claim 1, wherein a flat thermoplastic substrate is provided with a colour layer, by crosslinking a binder present in the colour with polyisocyanates.

6. The process according to claim 5, wherein the binder has a weight-average molecular weight in the range from 1000 to 50 000 g/mol.

7. The process according to claim 5, wherein the binder has a hydroxyl number in the range from 0.1 to 50 mg KOH/g.

8. The process according to claim 5, wherein the binder comprises a cellulose or a cellulose derivative, a polyurethane, a polyester, a polycarbonate, a polyamide or a poly(meth)acrylate.

9. The process according to claim 5, wherein an aliphatic polyisocyanate is used for crosslinking.

10. The process according to claim 5, wherein the colour is printed onto the polyamide film by means of screen printing processes.

11. The process according to claim 5, wherein an adhesion promoter layer is applied to the colour layer obtained by the printing with colour.

12. The process according to claim 11, wherein the adhesion promoter comprises cellulose or a cellulose derivative, a polyurethane, a polyester, a polycarbonate, a polyamide or a poly(meth)acrylate.

13. The process according to claim 11, wherein the adhesion promoter is printed onto the colour layer by means of screen printing processes.

14. The process according to claim 10, wherein the printed polyamide film is reformed.

15. The process according to claim 10, wherein the printed polyamide film is provided with a reinforcement layer.
